(19) United States
(12) Patent Application Publication
(10) Pub. No.: US 2006/0208044 A1
(43) Pub. Date: Sep. 21, 2006

(54) Double postcard

(75) Inventor: William Condon, Harrison Township, MI (US)

Correspondence Address: BROOKS KUSHMAN P.C., 1000 TOWN CENTER, TWENTY-SECOND FLOOR, SOUTHFIELD, MI, 48075, US

(73) Assignee: ROTARY MULTIFORMS, INC., Warren, MI (US)

(21) Appl. No.: 11/082,679

(22) Filed: Mar. 17, 2005

(51) Int. Cl. B42D 15/00

(52) U.S. Cl. 229/92.8

(57) ABSTRACT

A double postcard for concealing confidential information from casual observation comprises a tab closing the edges of the cards opposite the fold line with the outside of one of the cards having the recipient's address and, on the reverse thereof, information to be kept confidential from casual observation with a removable but non-replaceable shield overlying and obscuring the confidential information and removable therefrom for observing such information upon opening the folded cards at the tab.

### BACKGROUND OF THE INVENTION

1. Field of the Invention

This invention relates to Double Postcards wherein two cards are attached along a common edge, and mailed to a recipient who detaches one of the cards and mails it as a single card back to the sender or another.

2. Background Art

Double postcards have been used for many years. They enable the original sender to mail two cards for the price of one provided one of the cards is a return postcard. However, the Postal Service now requires that it be able to look inside and verify that there is a card to be detached and returned so that in fact a return card is present and not simply advertising or the like. Furthermore, the cards cannot be sealed in any fashion left or right, but only along the common edge (or fold line), and the edge opposite the fold must be held closed only in an approved fashion as, for example, by clear tape. If the double postcard does not contain a return postcard, first class rates apply.

The problem with the new postal regulation is that many return postcards contain sensitive information, such as tax information, for example, the amount of tax owed by the recipient and this is not the kind of information people want to be readily available to one picking up the card and casually squeezing it to see what is written on the inside. Accordingly, the need has arisen to prevent a casual inspection of a double postcard from revealing sensitive information which the recipient would prefer be kept confidential.

### SUMMARY OF THE INVENTION

To overcome the problem described above, I have devised a way to prevent casual inspection of confidential information inside a double postcard which is open at opposite ends to allow the Postal Service to verify that there is a return postcard thereby avoiding the extra postage charge. This is accomplished notwithstanding that the right and left hand edges of the double postcard are open when the card is squeezed across its longer edges. I accomplished this by having the confidential information on the inside of the double postcard and shielded from view. Such shielding may be accomplished by having a label or the like overlying the confidential information, which may be peeled off once the double postcard is opened. Another way of maintaining the information confidential is by a scratch-off covering, that is applied over the data or confidential information, exposing the data when scratched off by the recipient after the double postcard is opened.

### BRIEF DESCRIPTION OF THE DRAWINGS

FIG. 1 is front view of the outside of a sealed, double postcard, showing the outbound address;

FIG. 2 is a cross-sectional view taken on the line 2-2 of the FIG. 1;

FIG. 3 is the double postcard of FIG. 1 with the sealed edge open;

FIG. 4 is a view of my double postcard opened up flat with the outside (outgoing faces) exposed to view;

FIG. 5 is the opposite side (or inside) of the double postcard shown in FIG. 4 with the confidential information hidden beneath a removable shield or label;

FIG. 6 shows the outside of the front (or outgoing address) of my double postcard detached from the other half of the double postcard; and

FIG. 7 is the return side of the double postcard detached from the outgoing card.

### DETAILED DESCRIPTION OF THE PREFERRED EMBODIMENT(S)

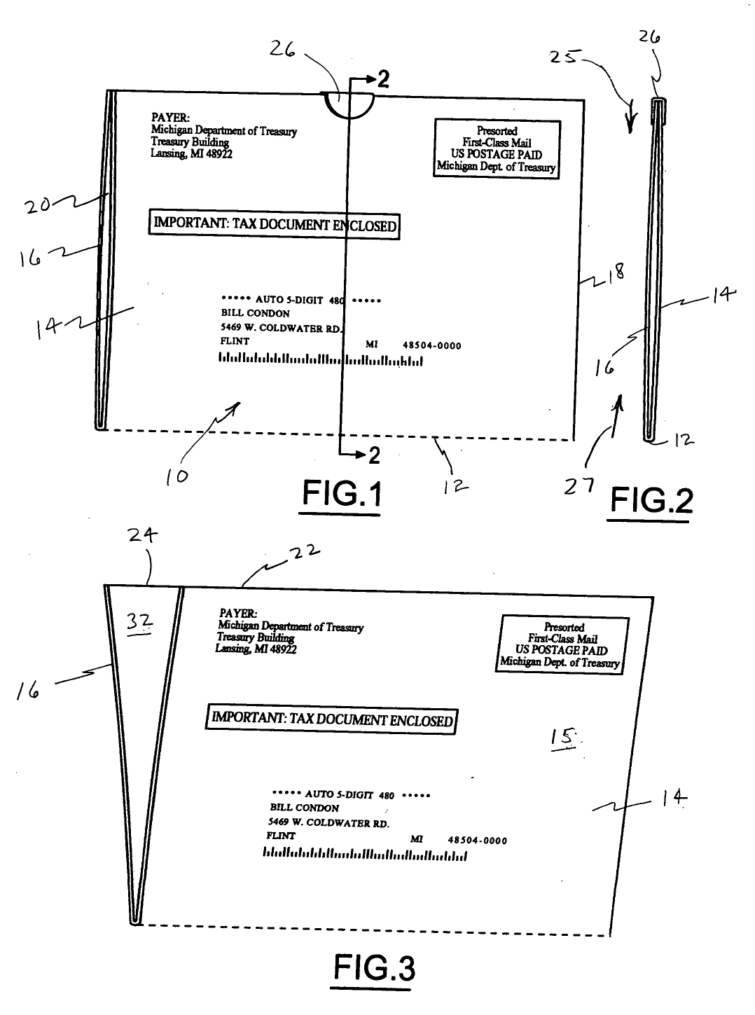

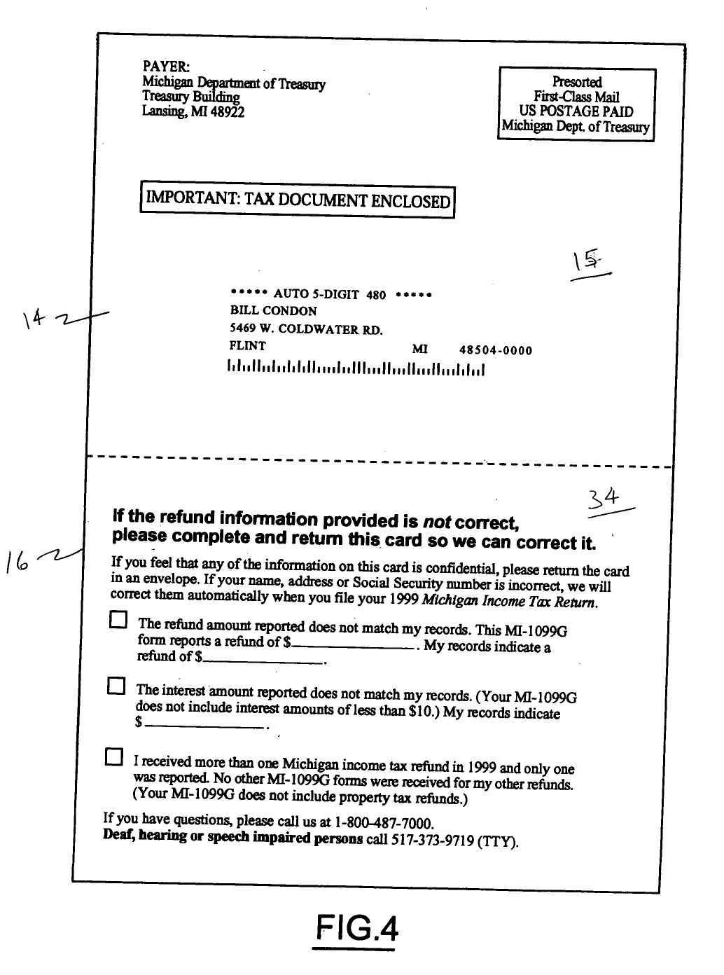

A double postcard for concealing confidential information from casual observation is shown in FIGS. 1 and 2 as formed of cardstock 10 which is folded in half along a separable fold line 12 creating a pair of cards 14 and 16 which are open at the right and left hand ends respectively 18 and 20 and are closed at the edges 22 and 24 by a tab 26 or other closure, qualifying under Postal Regulations DMM C100, opposite the fold line 12.

The card 14 will be retained by the recipient and the card 16 will be mailed back as a reply pursuant to Postal Specification DMM E110. When folded in half at the line 12, the double card will measure between 3½ inches by 5 inches and 4¼ inches by 6 inches overall. The piece will open to twice this size with the fold line or perforation line 12 allowing separation of the reply card 16 from the card 14 that is retained by the recipient.

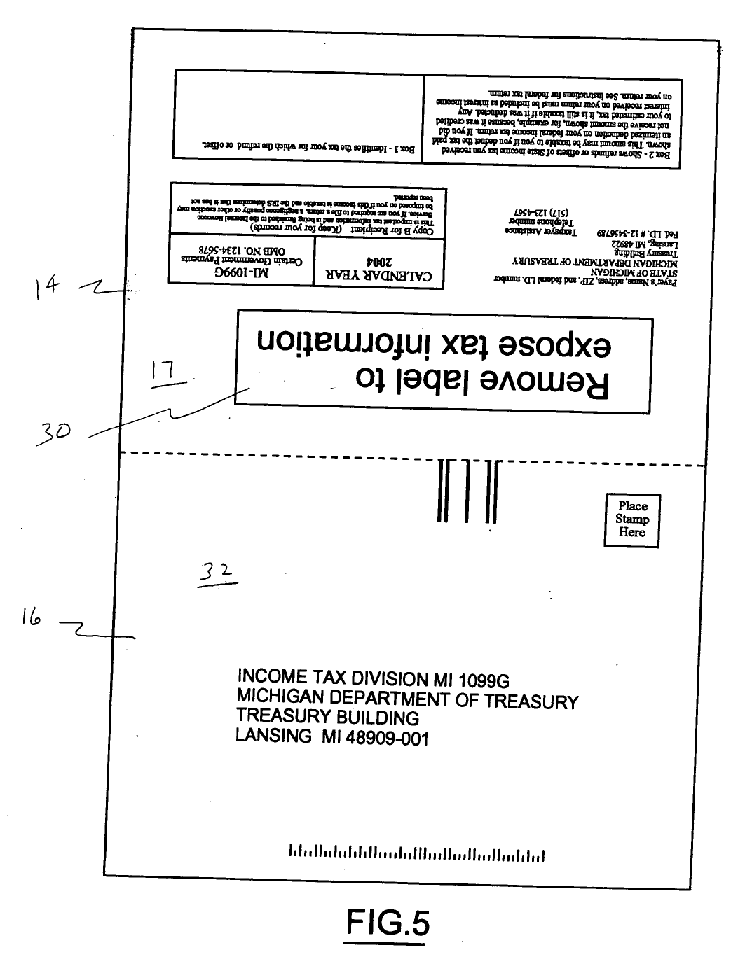

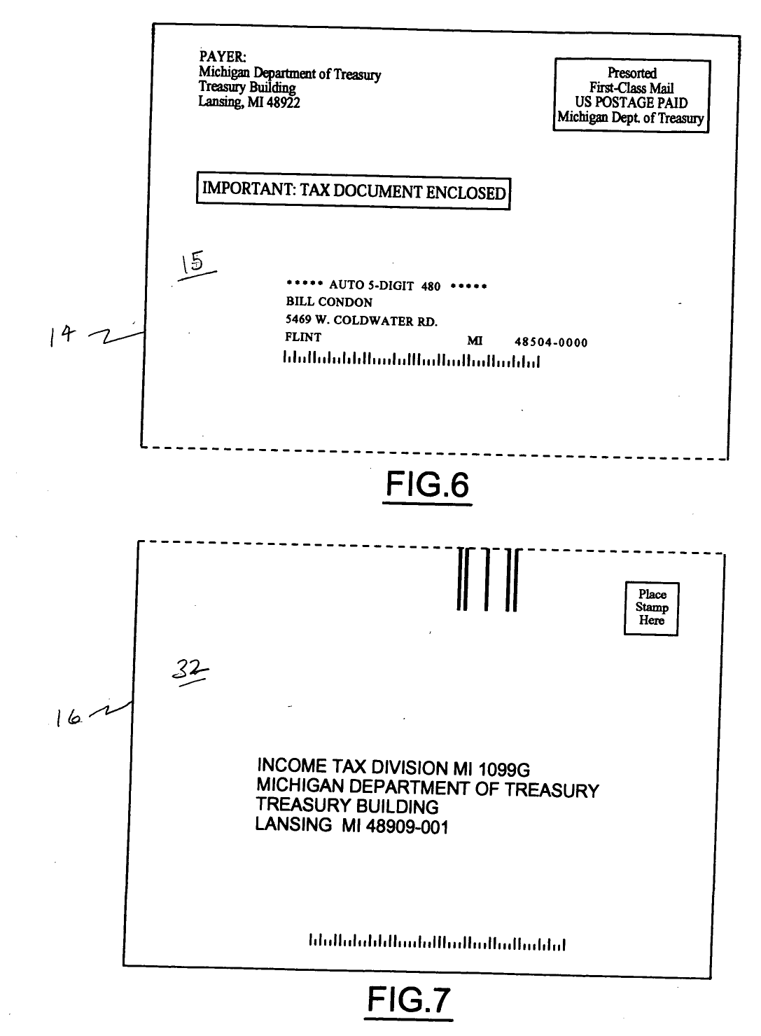

The intended recipient's address is shown on the outside surface 15 of card 14 in FIGS. 1 and 3. On the opposite face 17 of such card, as shown in FIG. 5, there appears the confidential information covered by a removable but non-replaceable shield 30 overlying and obstructing the view of the confidential information.

By grasping the card between thumb and forefinger and squeezing it in the directions of arrows 25 and 27 in FIG. 2, the inside faces 32 and 17 may be observed. The shield 30 will obscure the confidential information covered by the shield, but enough of the inside faces will be exposed to assure the Postal Service that the card is really a double postcard with a return card.

The shield 30 may take at least two forms:
(1) A translucent (or non-transparent) strip bonded to the face 17 of the card with the bonding such that the-shield 30 may be peeled off the card to expose the confidential information. Such shield may be formed using FASSON® REDEEM-A-LABEL™/S246/40# SCK. This is a white super-calendered facestock which is laminated to a low density polyethylene film. This is sold by Avery Dennison Corporation under the name FASSON S246. Once the shield has been peeled away, it cannot be re-attached simply by pressing it back against the card face.
(2) The shield may comprise a scratch-off material. One such material is offered by Craig Adhesives and Coatings of 80 Wheeler Point Rd., Newark, N.J. 07105 under the name CRAIGSEAL 250011. This is a solvent-based silver scratch-off coating for screen print and roll coat applications. It is used in conjunction with CRAIGSOLVE 365F diluent. Other scratch-offs may also be used.

Whether the shield is formed of a strip bonded to the card and overlying the confidential information, or is a scratch-off material, the shield cannot be re-attached to the card surface 17 so that if the card has been tampered with to expose the confidential information, such will appear from the character of the shield. If the shield is dangling from the card face 17, or it appears to have been scratched or scraped, such will be readily apparent to the recipient.

The inside face 32 of the card 16 shows the return postal address of the original sender and when card 16 is detached from card 14, the card 16 may be used to mail information back to the original sender, for example, as shown on the face of card 16.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A double postcard for concealing confidential information from casual observation comprising:
cardstock folded in half along a separable fold line creating a pair of cards open at the right and left hand ends;
a tab or other postal regulation qualifying closure, closing the edges of the cards opposite the fold line;
the outside of one of the cards having the recipient's address and on the reverse thereof information to be kept confidential from casual observation from either the right or left hand ends of the folded cardstock when the same is squeezed between the fold line and the edges of the cards at the tab opposite the fold line;
the outside of the other card having a message to the recipient from the sender and the opposite side of such card having the return address of the sender; and
a removable but non-replaceable shield overlying and obscuring the confidential information and removable therefrom for observing such information upon opening the folded cards at the tab.

2. The invention defined by claim 1 wherein the shield comprises a label removably bonded to the card over said information and obstructing the view of such information until peeled from the card.

3. The invention defined by claim 2 wherein said label is attached to the card.

4. The invention defined by claim 1 wherein the shield comprises a non-transparent coating on the card covering said confidential information and which is scrapable therefrom to expose the confidential information for visual inspection.

5. The invention defined by claim 4 wherein the scratch-off material concealing the confidential information comprises a solvent-based coating.
